(19) United States
(12) Patent Application Publication
(10) Pub. No.: US 2025/0189348 A1
(43) Pub. Date: Jun. 12, 2025

(54) INDUCTIVE POSITION MEASURING DEVICE

(71) Applicant: DR. JOHANNES HEIDENHAIN GmbH, Traunreut (DE)

(72) Inventors: Alexander FRANK, Traunstein (DE); Martin HEUMANN, Traunstein (DE); Marc Oliver TIEMANN, Tettenhausen (DE)

(21) Appl. No.: 18/969,848

(22) Filed: Dec. 5, 2024

(30) Foreign Application Priority Data
Dec. 7, 2023 (EP) 23214815.5

(51) Int. Cl. G01D 5/20

(52) U.S. Cl. CPC G01D 5/20

(57) ABSTRACT

An inductive position measuring device has a scale element and a sensing element that is movable relative thereto. The sensing element has an excitation line, a first receiving track, and a second receiving track. The scale element has a carrier layer made of a first electrically conductive material, a first graduation track, and a second graduation track. The first graduation track and the second graduation track are arranged on the carrier layer and are formed from alternately arranged webs and gaps, in which the webs are made of a second electrically conductive material that differs from the first material of the carrier layer. A shielding web made of electrically conductive material is arranged between the first graduation track and the second graduation track.

### CROSS-REFERENCE TO RELATED APPLICATIONS

The present application claims priority to application No. 23214815.5, filed on Dec. 7, 2023, which is expressly incorporated herein in its entirety by reference thereto.

### FIELD OF THE INVENTION

The present invention relates to an inductive position measuring device, e.g., for determining relative positions.

### BACKGROUND INFORMATION

Inductive position measuring devices are used, for example, as measuring devices for determining the relative position of two elements that are movable or rotatable in relation to each other. In inductive position measuring devices, excitation coils and receiving coils, for example, in the form of conductor tracks, are often applied to a common, usually multilayer circuit board, in which this unit may be referred to as a sensing element. Opposite this sensing element is a scale element on which, for example, webs and gaps are arranged as a graduation structure. When a time-varying electrical excitation current is applied to the excitation line, signals dependent on the relative position are generated in the receiving coils or lines during the relative movement between the scale element and the sensing element. These signals are further processed in an evaluation electronic system.

European Patent Document No. 2 515 086 describes an inductive position measuring device having a scale consisting of different metal layers.

### SUMMARY

With the use of a position measuring device, a linear position of the sensing element relative to the scale element can be determined. Additionally, a position measuring device may also be used for determining an angular position of the sensing element relative to the scale element. For example, the position measuring device can generate absolute position information.

Example embodiments of the present invention provide an inductive position measuring device that makes it possible to determine, with high measuring accuracy and in a simple manner, a relative position in a first direction extending along receiving tracks.

According to example embodiments, an inductive position measuring device has a sensing element and a scale element. The sensing element is movable or displaceable relative to the scale element or along a first direction. The first direction may be a linear direction or, in the case of a detection of an angular position, a circumferential direction. The sensing element has at least one excitation line. Furthermore, the sensing element has a first receiving track including at least one receiving line that extends along the first direction according to a first periodic pattern. Likewise, the sensing element has a second receiving track including at least one receiving line that extends along the first direction according to a second periodic pattern and is offset in a second direction with respect to the first receiving track, so that a spacer strip extends between them along the first direction. The second direction is oriented orthogonal to the first direction. The scale element has a carrier layer made of a first electrically conductive material, as well as a first graduation track and a second graduation track. The second graduation track is arranged offset in the second direction with respect to the first graduation track. The first graduation track and the second graduation track are arranged on the carrier layer and are formed from webs and gaps arranged alternately along the first direction. The webs include a second electrically conductive material or are made of a second electrically conductive material that differs from the first material of the carrier layer, and the webs and the carrier layer are electrically conductively connected to one another. Between the first graduation track and the second graduation track (in relation to the second direction) there is a shielding web or, a shielding web is arranged, which also includes or consists of an electrically conductive material. The shielding web is arranged offset in a third direction opposite the spacer strip. The third direction is oriented orthogonal to the first direction and the second direction.

The first receiving track is thus arranged offset from the second receiving track in the second direction, so that there is a spacer strip extending between them in the second direction. The spacer strip also extends along the first direction. For example, the width of the spacer strip may extend in the second direction and its length may extend in the first direction. The material of the shielding web corresponds to the electrically conductive second material of the webs.

Both the webs and the shielding web are raised in relation to the carrier layer in the third direction. For example, the webs and the shielding webs respectively have the same extension or height in the third direction. For example, the webs have an extension of at least 5 μm, e.g., at least 10 μm, in the third direction.

For example, the graduation tracks are created by structuring an electrically conductive first layer, e.g., by laser processing or laser ablation.

According to example embodiments, the first material of the carrier layer is in the group of ferritic stainless steels. The first material from which the carrier layer is made is thus, for example, a ferritic stainless steel.

For example, the first material of the carrier layer has a permeability index of at least 100, e.g., at least 500, at least 1,000, etc. The permeability index is a measure of the magnetic permeability or magnetic conductivity of the first material of the carrier layer.

For example, the scale element has a compensation layer, in which the carrier layer is arranged between the graduation tracks and the compensation layer in relation to the third direction. For example, the compensation layer may be made of the same second material as the webs.

The first electrically conductive material of the carrier layer may have, for example, a higher specific resistance than the second electrically conductive material of the webs and/or the shielding web. For example, the specific resistance of the first electrically conductive material of the carrier layer may be at least 10 times greater than the specific resistance of the second electrically conductive material. On the other hand, the first electrically conductive material of the carrier layer may have a specific resistance of less than 1 Ω mm²/m.

For example, the extension in or along the first direction of exactly one web and exactly one gap of the first graduation track has a first period length in total. In addition, the extension in the first direction of exactly one web and exactly one gap of the second graduation track has a second period length in total. The first period length and the second period length are of different lengths.

For example, the first periodic pattern of the receiving line of the first receiving track has the first period length and the second periodic pattern of the receiving line of the second receiving track has the second period length. As mentioned above, the first period length and the second period length are of different lengths. The first and/or the second periodic pattern may have a sinusoidal path. The position measuring device is configured such that an electromagnetic field generated by the excitation line may be modulated by the graduation track. A first signal with the first period length may thus be generated by the receiving line of the first receiving track, and a second signal with the second period length may be generated by the receiving line of the second receiving track. With the position measuring device, an absolute position of the scale element relative to the sensing element may be determined by the receiving line of the first receiving track and by the receiving line of the second receiving track, e.g., according to the Nonius principle.

According to example embodiments, the shielding web extends along the first direction over a length that is greater than the first period length or the second period length, i.e., greater than the greater of the period lengths.

Further features and aspects of example embodiments of the present invention are described in more detail below with reference to the appended schematic Figures.

### BRIEF DESCRIPTION OF THE DRAWINGS

FIG. 1 is a cross-sectional view of a blank for a scale element.

FIG. 2 is a cross-sectional view of the scale element and a sensing element.

FIG. 3 is a further cross-sectional view of the scale element.

FIG. 4 is a top view of the scale element.

FIG. 5 is a top view of the sensing element.

FIG. 6 is an enlarged top view of the sensing element, e.g., of the first and second receiving tracks and the excitation line.

FIG. 7 is a view of the position measuring device in the direction of measurement.

### DETAILED DESCRIPTION

Example embodiments of the present invention are described with reference to a position measuring device that is intended for detecting an absolute relative position between a sensing element 1 (see, e.g., FIGS. 2, 5 and 7), which is movable along a first direction X (measuring direction), and a scale element 2 or a scale.

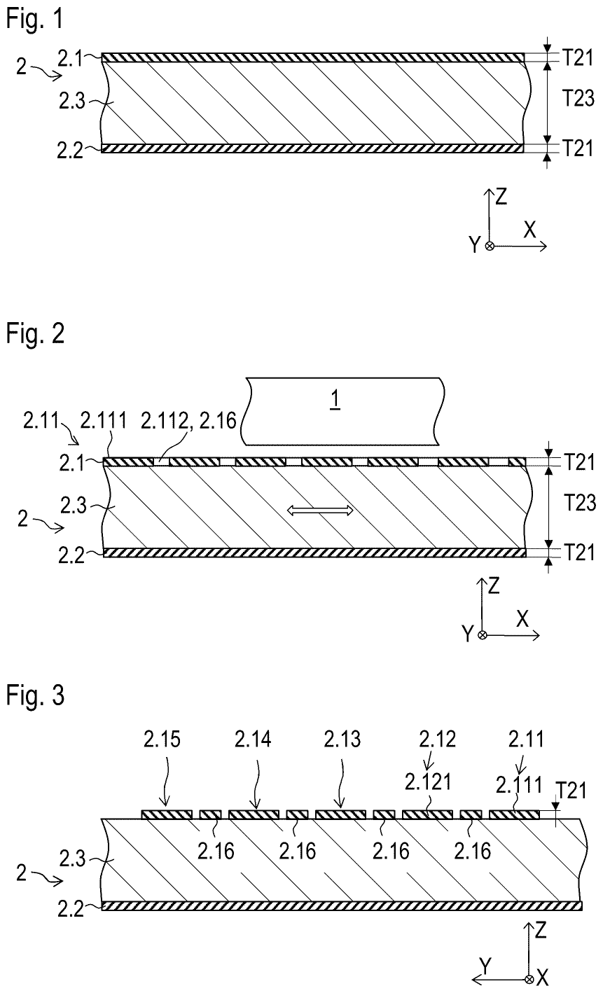

In the illustrated example, the scale element 2 is manufactured from a multi-layered semi-finished product, as illustrated in a cross-sectional view in FIG. 1. In the illustrated example, the scale element 2 includes a comparatively thick carrier layer 2.3, in the thickness T23 of the carrier layer 2.3 in the illustrated example is 0.3 mm. The first material used for the carrier layer 2.3 is a ferritic stainless steel with a permeability index of between 100 and 2,000. For example, EN 1.4016 steel may be used for the carrier layer 2.3. This steel has a specific electrical resistance of approximately 0.60 Ω mm²/m.

The above-mentioned semi-finished product or the blank for the scale element 2, also includes a graduation layer 2.1 on one side of the carrier layer 2.3 and a compensation layer 2.2 on the opposite side of the carrier layer 2.3. The graduation layer 2.1 and the compensation layer 2.2 are made of the same second material, for example, aluminum or copper (the specific electrical resistance of Al is 0.027 Ω mm²/m, and of Cu is 0.017 Ω mm²/m) and have the same thickness or extension T21 in a third direction Z, e.g., 24 μm. Both the graduation layer 2.1 and the carrier layer 2.3 as well as the compensation layer 2.2 are thus electrically conductive, and the graduation layer 2.1 and the carrier layer 2.3 as well as the compensation layer 2.2 and the carrier layer 2.3 are in direct contact with each other, so that they are electrically conductively connected.

In the course of manufacturing the scale element 2, the graduation layer 2.1, which is arranged directly on the carrier layer 2.3, is structured using a laser ablation process. The graduation layer 2.1 is ablated in places by a laser beam over the entire thickness T21. As a result, a first graduation track 2.11, a second graduation track 2.12, a third graduation track 2.13, a fourth graduation track 2.14, and a fifth graduation track 2.15 are created (see, e.g., FIGS. 2 and 3). The graduation tracks 2.11 to 2.15 are arranged offset from each other in a second direction Y.

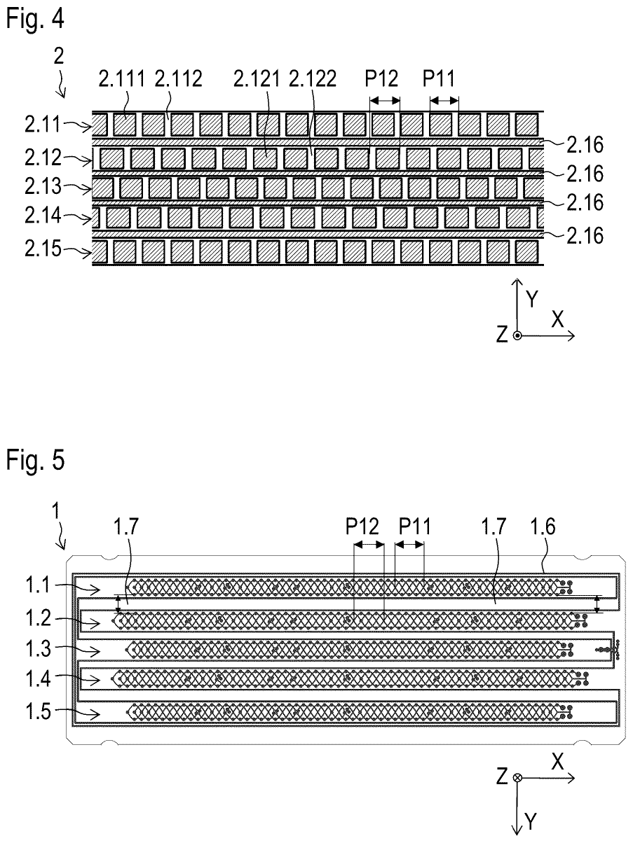

The formation of the graduation tracks 2.11 to 2.15 is described in more detail below with reference to the first graduation track 2.11 and the second graduation track 2.12. As illustrated in FIG. 4, the first graduation track 2.11 and the second graduation track 2.12 are formed from webs 2.111, 2.121 and gaps 2.112, 2.122, which are arranged alternately or alternatingly along the first direction X, so that gaps 2.112, 2.122 are present between the webs 2.111, 2.121, respectively. The graduation tracks 2.11, 2.12 thus include or consist of a sequence of alternately arranged webs 2.111, 2.121, respectively, and gaps 2.112, 2.122, respectively. In the first graduation track 2.11, with respect to the first direction X, the sum of the length of one web 2.111 and one gap 2.112 corresponds to a first period length P11. Similarly, in the second graduation track 2.12, the sum of the length of one web 2.121 and one gap 2.122 corresponds to a second period length P12. Within a period length P11, P12 there is thus exactly one web 2.111, 2.121, respectively, and one gap 2.112, 2.122, respectively.

Furthermore, when structuring the graduation layer 2.1 in the course of laser ablation, a so-called shielding web 2.16 is created or left in place. This shielding web 2.16 is arranged between the first graduation track 2.11 and the second graduation track 2.12 in relation to the second direction Y and extends along the first direction X. The length of the shielding web 2.16 in the first direction X is substantially greater than the first period length P11 or the second period length P12. The webs 2.111, 2.121 and the shielding web 2.16 are made of the same second material and are electrically conductive. The first material of the carrier layer 2.3 is also electrically conductive. A current flow is thus possible between the carrier layer 2.3 and the webs 2.111, 2.121, as well as between the carrier layer 2.3 and the shielding web 2.16.

The third to fifth graduation tracks 2.13 to 2.15 are arranged in the same manner, with further shielding webs 2.16 arranged between them. The shielding webs 2.16 all have the same thickness or extension T21 in the third direction Z, as do the webs 2.111, 2.121 of the first and second graduation tracks 2.11, 2.12. The same applies to the third to fifth graduation tracks 2.13 to 2.15. In this manner, a scale element 2 is produced, which is illustrated in the top view of FIG. 4 (where the surfaces of the webs 2.111, 2.121 and shielding webs 2.16 are denoted by hatching).

The carrier layer 2.3 is arranged between the graduation tracks 2.11, 2.12 and the compensation layer 2.2 in relation to the third direction Z. The main purpose of the compensation layer 2.2 is to ensure high dimensional stability and good flatness of the scale element 2.

FIG. 5 is a top view of the sensing element 1, which is arranged as a printed circuit board with a plurality of layers, with electronic components mounted on the rear side, which is not visible in FIG. 5. The sensing element 1 is used to sense the scale element 2.

To determine the relative position between the scale element 2 and the sensing element 1, the sensing element 1 has a first receiving track 1.1, a second receiving track 1.2, a third receiving track 1.3, a fourth receiving track 1.4, and a fifth receiving track 1.5. The receiving tracks 1.1 to 1.5 are enclosed by an excitation line 1.6.

As illustrated in FIG. 5, the receiving tracks 1.1 to 1.5 are arranged offset to one another in the second direction Y, with a distance in the second direction Y between two adjacent receiving tracks 1.1 to 1.5, so that a spacer strip 1.7 exists there.

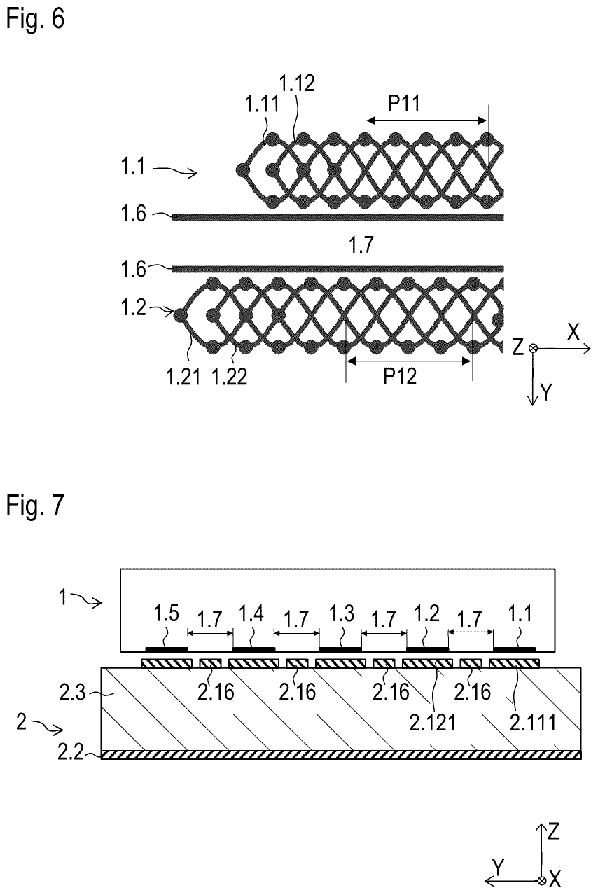

In FIG. 6, the first receiving track 1.1 and the second receiving track 1.2 are illustrated enlarged in a detailed view. The first receiving track 1.1 includes a first receiving line 1.11 and a second receiving line 1.12. In the same manner, the second receiving track 1.2 includes a third receiving line 1.21 and a fourth receiving line 1.22.

In the illustrated example embodiment, each of the first receiving track 1.1 and the second receiving track 1.2 includes two receiving lines 1.11, 1.12, 1.21, 1.22, which are arranged offset in the first direction X, so that they can supply two phase-shifted signals corresponding to the offset. The receiving lines 1.11, 1.12, 1.21, 1.22 are arranged as conductor tracks and are connected to vias in different layers of the printed circuit board or the sensing element 1, so that unwanted short circuits are avoided at crossing points. Although, strictly speaking, each of the receiving lines 1.11, 1.12, 1.21, 1.22 includes, or consists of, many conducting pieces, each of which is distributed and strung together on a plurality of different planes or layers, such a structure is collectively referred below to as one receiving line 1.11, 1.12, 1.21, 1.22.

The first receiving line 1.11 extends according to a first periodic pattern along the first direction X, and the second receiving line 1.12 extends according to a second periodic pattern. For example, the receiving lines 1.11, 1.12, 1.21, 1.22 have a spatially periodic path, which is substantially sine-shaped or sinusoidal, in which all receiving lines 1.11, 1.12 of the first receiving track 1.1 have a first period length P11 (see, e.g., FIG. 6). The receiving lines 1.21, 1.22 of the second receiving track 1.2 have a second period length P12. For example 1, the second period length P12 is greater than the first period length P11.

In the illustrated example embodiment, the receiving lines 1.11, 1.12 are offset from each other by ¼ of the first period length P11 along the first direction X within the first receiving track 1.1. The receiving lines 1.11, 1.12 are electrically connected such that they supply 0° and 90° signals from which a first position signal can be determined. The first receiving lines 1.11, 1.12 may be used to generate a comparatively high-resolution incremental signal when the scale element 2 moves relative to the sensing element 1. In the example embodiment illustrated in FIG. 6, the second receiving track 1.2 includes a third receiving line 1.21 and a fourth receiving line 1.22, i.e., two receiving lines 1.21, 1.22, which are arranged offset to each other in the first direction X, so that they can supply two signals phase-shifted by 90° according to the offset. The receiving lines 1.21, 1.22 are arranged as conductor tracks and are also connected with vias in different layers of the printed circuit board or the sensing element 1.

The first period length P11 on the sensing element 1 is the smallest period length, which is the same size as the period length of the fifth receiving track 1.5. The middle, third receiving track 1.3 has a period length that is slightly greater than the first period length P11. The second period length P12 as well as the period length of the fourth receiving track 1.4 are greater than the first period length P11 and are greater than the period length of the third receiving track 1.3. The same consideration with regard to the period lengths also applies analogously to the graduation tracks 2.11 to 2.15 of the scale element 2.

In the assembled state of the position measuring device as illustrated in FIG. 7, the sensing element 1 and the scale element 2 face each other with an air gap extending in the third direction Z. During a relative movement between the scale element 2 and the sensing element 1, a signal dependent on the relative position can be generated in the receiving lines 1.11, 1.12, 1.21, 1.22 by induction effects. A prerequisite for the formation of corresponding signals is that the excitation line 1.6 generates a time-varying electromagnetic excitation field in the region of the sensed graduation tracks 2.11 to 2.15. In the illustrated example embodiment, the excitation line 1.6 is arranged as a plurality of planar-parallel current-carrying individual conductor tracks. The sensing element 1 has an electronic circuit with the electronic components. The electronic circuit may also include an ASIC component. This electronic circuit of the sensing element 1 operates not only as an evaluation element, but also as an excitation control element under whose control the excitation current is generated or produced, which flows through the excitation line 1.6.

If the excitation line 1.6 is supplied with current, a tubularly or cylindrically oriented electromagnetic field is formed around the excitation line 1.6. The field lines of the resulting electromagnetic field extend around the excitation line 1.6, in which the direction of the field lines depends on the direction of the current in the excitation line 1.6. Eddy currents are induced in the area of the webs 2.111, 2.121, so that a modulation of the field is achieved, which is dependent on the relative position. Accordingly, the relative position may be measured by the receiving lines 1.11, 1.12, 1.21, 1.22.

All receiving lines 1.11, 1.12 of the first receiving track 1.1 have the same first period length P11, and the receiving lines 1.21, 1.22 of the second receiving track 1.2 have the same second period length P12. The sensing of both receiving tracks 1.1, 1.2 occurs simultaneously. Switching between individual receiving tracks 1.1, 1.2 is not necessary. When a web 2.111, 2.121 and a gap 2.112, 2.122 are crossed over, a signal period is generated by the sensing element 1. The first receiving track 1.1 with its receiving lines 1.11, 1.12, which extend with a smaller first period length P11, senses the scale element 2, so that a comparatively fine determination of the relative position can be achieved by the first receiving track 1.1. At the same time, the neighboring second receiving track 1.2 with its receiving lines 1.21, 1.22, which extend with a coarser second period length P12, senses the scale element 2. The second receiving track 1.2 thus provides for a comparatively coarser determination of the relative position.

Similarly, signals are generated or received in the third, fourth, and fifth receiving track 1.3 to 1.5 when sensing the third, fourth, and fifth graduation track 2.13 to 2.15.

The signals received are linked using a beat or Nonius algorithm so that the relative position between the sensing element 1 and the scale element 2 can be determined absolutely using the signals.

The provision of five graduation tracks 2.11 to 2.15 and five receiving tracks 1.1 to 1.5 has the advantage, for example and among others, that the measurement is comparatively insensitive to a rotation of the scale element 2 relative to the sensing element 1 (minimization of the Moirè error).

In directly adjacent receiving tracks 1.1, 1.2, the configuration of the graduation tracks 2.11, 2.12 described herein would produce a crosstalk signal that typically has a sinusoidal shape with a crosstalk period length of approximately fifteen second period lengths P12 or sixteen first period lengths P11. The lengths of the receiving lines 1.21, 1.22 in the first direction X correspond approximately to this crosstalk period length. This dimensioning can help to reduce crosstalk within certain limits from the outset when sensing directly adjacent graduation tracks 2.11, 2.12. Crosstalk effects can nevertheless be detected when using conventional scale elements with an electrically conductive graduation on an electrically conductive substrate. The measures described herein make it possible to significantly minimize crosstalk and thus improve measurement accuracy.

What is claimed is:

1. An inductive position measuring device, comprising:
a scale element; and
a sensing element movable relative to the scale element in a first direction;
wherein the sensing element includes:
at least one excitation line;
a first receiving track including at least one receiving line that extends along the first direction according to a first periodic pattern; and
a second receiving track including at least one receiving line that extends along the first direction according to a second periodic pattern and is arranged offset in a second direction with respect to the first receiving track, so that a spacer strip extends between the first receiving track and the second receiving track in the first direction;
wherein the scale element includes:
a carrier layer made of a first electrically conductive material;
a first graduation track; and
a second graduation track arranged offset in the second direction with respect to the first graduation track;
wherein the first graduation track and the second graduation track are arranged on the carrier layer and are formed from webs and gaps arranged alternately along the first direction;
wherein the webs are made of a second electrically conductive material that differs from the first material of the carrier layer;
wherein, in relation to the second direction, a shielding web, made of an electrically conductive material, is arranged between the first graduation track and the second graduation track;
wherein the shielding web is arranged offset in a third direction opposite the spacer strip, the third direction being oriented orthogonal to the first direction and to the second direction.

2. The inductive position measuring device according to claim 1, wherein the first material of the carrier layer is a ferritic stainless steel.

3. The inductive position measuring device according to claim 1, wherein the graduation tracks are arranged as a structured electrically conductive graduation layer.

4. The inductive position measuring device according to claim 1, wherein the graduation tracks are generated by structuring an electrically conductive graduation layer.

5. The inductive position measuring device according to claim 1, wherein the webs and the shielding web have a same thickness in the third direction.

6. The inductive position measuring device according to claim 1, wherein the webs have a thickness of at least 5 μm in the third direction.

7. The inductive position measuring device according to claim 1, wherein the webs have a thickness of at least 10 μm in the third direction.

8. The inductive position measuring device according to claim 1, wherein the first material of the carrier layer has a permeability index of at least 100.

9. The inductive position measuring device according to claim 1, wherein the first material of the carrier layer has a permeability index of between 100 and 2,000.

10. The inductive position measuring device according to claim 1, wherein the scale element includes a compensation layer, the carrier layer being arranged between the graduation tracks and the compensation layer relative to the third direction.

11. The inductive position measuring device according to claim 10, wherein the compensation layer includes the second electrically conductive material.

12. The inductive position measuring device according to claim 1, wherein the first electrically conductive material of the carrier layer has a higher specific resistance than the second electrically conductive material of the webs.

13. The inductive position measuring device according to claim 1, wherein the first electrically conductive material of the carrier layer has a higher specific resistance than the second electrically conductive material of the webs and/or of the electrically conductive material of the shielding web.

14. The inductive position measuring device according to claim 13, wherein the electrically conductive material of the shielding web includes the second electrically conductive material of the webs.

15. The inductive position measuring device according to claim 1, wherein one of the webs and one of the gaps of the first graduation track has a first period length in total in the first direction, and one of the webs and one of the gaps of the second graduation track has a second period length in total in the in the first direction, the first period length and the second period length being different.

16. The inductive position measuring device according to claim 1, wherein the first periodic pattern has a first period length, and the second periodic pattern has a second period length, the first period length and the second period length being different.

17. The inductive position measuring device according to claim 1, wherein the first periodic pattern has a first period length, and the second periodic pattern has a second period length, the shielding web extending along the first direction over a length that is greater than the first period length and/or the second period length.

18. The inductive position measuring device according to claim 1, wherein the scale element includes a third graduation track, a fourth graduation track, a fifth graduation track, and respective shielding webs arranged between the second graduation track and the third graduation track, between the third graduation track and the fourth graduation track, and between the fourth graduation track and the fifth graduation track, each of the third graduation track, the fourth graduation track, and the fifth graduation track arranged on the carrier layer and formed from webs and gaps arranged alternately along the first direction.

19. The inductive position measuring device according to claim 1, wherein the sensing element includes a third receiving track including at least one receiving line that extends along the first direction according to a third periodic pattern and arranged offset in the second direction with respect to the second receiving track so that a second spacer strip extends between the second receiving track and the third receiving track, a fourth receiving track including at least one receiving line that extends along the first direction according to a fourth periodic pattern and arranged offset in the second direction with respect to the third receiving track so that a third spacer strip extends between the third receiving track and the fourth receiving track, and a fifth receiving track including at least one receiving line that extends along the first direction according to a fifth periodic pattern and arranged offset in the second direction with respect to the fourth receiving track so that a fourth spacer strip extends between the fourth receiving track and the fifth receiving track.

20. The inductive position measuring device according to claim 19, wherein a first period length of the first receiving track and a fifth period length of the fifth receiving track are the same, a third period length of the third receiving track is greater than the first period length, and a second period length of the second receiving track and a fourth period length of the fourth receiving track are greater than a second period length of the second receiving track and a fourth period length of the fourth receiving track are greater than the first period length the first period length and are greater than the third period length.
